(19) United States
(12) Patent Application Publication
(10) Pub. No.: US 2014/0362213 A1
(43) Pub. Date: Dec. 11, 2014

(54) RESIDENCE FALL AND INACTIVITY MONITORING SYSTEM

(71) Applicant: Vincent Tseng, Redmond, WA (US)

(72) Inventor: Vincent Tseng, Redmond, WA (US)

(21) Appl. No.: 13/910,868

(22) Filed: Jun. 5, 2013

(51) Int. Cl. G08B 21/04; H04N 7/18

(52) U.S. Cl. CPC G08B 21/0476; H04N 7/183
USPC 348/143

(57) ABSTRACT

A surveillance system for residential buildings that monitors the status of occupants for their location, position, and movement. The system employs a sensor that is mounted near the ceiling or on the floor in each room of the residence. Each sensor continuously scans the X, Y and Z axes for the location and position of objects each room. The sensors are coupled to a digital image processor that uses software to evaluate the stream of location and position data to determine whether occupants are moving, and whether their activity indicates an or normal or emergency condition. The surveillance system can be adapted for any building or room configuration because upon setup it generates and stores a database of map information about the building it is installed within and that map data is thereafter used to evaluate the stream of location and position data. When abnormal location, position or movement of a monitored object, typically a senior citizen, is detected by the system an alarm state is automatically triggered and an emergency notification signal is transmitted to emergency response personnel.

### CROSS-REFERENCE TO RELATED APPLICATION

U.S. provisional application No. 61/655,582 dated Jun. 5, 2012 the contents of which are hereby incorporated by reference.

### FIELD OF THE INVENTION

The present invention generally relates to residential monitoring systems, and more particularly to monitoring systems adapted to detect falls or prolonged periods of inactivity that might indicate an emergency situation inside a residence.

### BACKGROUND OF THE INVENTION

Many senior citizens live alone in homes and apartments and are isolated from people who could help them in an emergency. Even when seniors live with others, with relatives or in assisted living facilities for example, they are often housed in separate living quarters such as a guest house or otherwise left alone for long periods. As a result seniors often find themselves in physically isolated situations where a fall, injury, or life threatening medical conditions can go undetected by family or support staff for an extended period of time. Because falling down is a common occurrence among seniors, many seniors carry or wear emergency call buttons that may be manually activated to alert others when assistance is needed. Alternately, emergency call buttons are often mounted in the bathrooms or bedrooms of a residence so that the ability to request assistance is never more than a few paces away from any point inside the residence. Despite these options for requesting help in an emergency, many seniors forget or refuse to wear an emergency call button or may not be able to reach a call button because of incapacity or disorientation during acute traumatic events. In addition, many seniors are reluctant to call for help out of fear of inconveniencing others. What is needed is a fall monitoring system that enables emergency personnel and support staff to be alerted to an emergency condition faced by a senior without the need for the senior to make any volitional request for help. The system should learn a senior's normal living patterns and then be able to identify emergencies and alert support staff automatically.

### RELEVANT ART REFERENCES

U.S. 2009/0209850 A1 (Tao et al.) teaches a pulsed ultra-wideband sensor and method thereof, that calculates respiratory and heart rates.

U.S. 2005/0033200 A1 (Soehren et al.) teaches a human motion identification and measurement system and method that can also sense metabolism, and trigger an alarm.

U.S. 2003/00581111 A1 (Lee et al.) teaches a computer vision based elderly care monitoring system and method for monitoring a person of interest in a scene comprising capturing image data of the scene; detecting and tracking the person of interest in the image data, analyzing features of the person of interest and detecting emergency events.

U.S. Pat. No. 8,068,051 (Osterweil) teaches a method and apparatus for a body position monitor using radar. The radar system includes transmitters or receivers and a signal processor that processes reflected signals. Doppler analysis of the reflected signal determines the activity and location of a subjects upper torso, and the subjects presence within the monitored premises.

U.S. Patent No. 7,987,069 (Rogers et al.) teaches a system that uses motion cameras located in a patient's room that compare the captured motion data to a library of motion data in order to determine if the patient assigned to the room is attempting to escape. When an escape is detected, remedial measures are taken.

U.S. Pat. No. 7,916, 006 (Osterweil) teaches a method and apparatus for a body position monitor and fall detector using radar.

U.S. Pat. No. 7,567,200 (Osterweil) teaches a radar-based fall detector system that uses Doppler analysis of a reflected radar signal to determine an individual's movement and distance to the floor. The Doppler UWB radar signals have the ability to detect a beating heart, or the movement of a person's chest when breathing. When a person falls, the system is able to detect the distance of the individual's heart and chest from the floor. If the individual is determined to be horizontal a fall alarm is triggered.

U.S. Pat. No. 7,532, 126 (Young et al.) teaches a remote homecare monitoring system and method thereof that includes a behavior detector, an image capture device, and a gateway. The behavior detector detects an abnormal activity or behavior, the image capture device gets an image of the users condition, and the gateway transmits the images to a contact person.

U.S. Pat. No. 7,502, 498 (Wen et al.) teaches a patient monitoring apparatus that includes one or more cameras to determine a 3d model of a person to determine a dangerous condition which in generates a warning.

U.S. Pat. No. 7,307,522 (Dawson et al.) teaches a system and method for determining the location of a resident during an emergency within a monitored area having a plurality of residences using a wireless emergency radio frequency transmitter and receiver. In response to receiving an infrared or acoustic signal the system transmits an RF signal containing the location code.

U.S. Pat. No. 7,110,569 (Brodsky et al.) teaches a video based detection system of fall down and other event. The system captures image data, detects and tracks objects of interest in the image data, analyzes features of the object of interest, comparing the analyzed features with predetermined criteria, determining whether a specific event has occurred based upon the comparison.

U.S. Pat. No. 7,064, 701 (Steinway et al.) teaches a concealed object detection system for detecting objects concealed on a person using a radar.

U.S. Pat. No. 6,774, 789 B2 (Inaba et al.) teaches a Human body detector that uses a wave detection circuit for detecting waves of resonance of a voltage connected to a sensor resonance circuit that varies a constant frequency voltage in accordance with a change in the capacitance of a sensor electrode.

U.S. Pat. No. 6,108,685 (Menache) teaches a method for tracking objects within a three dimensional capture zone using at least four radio frequency sensors around the zone.

U.S. Pat. No. 6,108,685 (Kutzik et al.) teaches a system for monitoring a user in a living area. Daily living activity is monitored and reported to a system controller. The system assesses movement around the home, medication compliance, problems with stoves and other appliances.

U.S. Pat. No. 5,905,436 (Dwight et al.) teaches a situation-based monitoring system that determines when a person is in distress and communicates that fact to appropriate personnel.

U.S. Pat. No. 5,790, 032 (Schmidt) teaches a method of and apparatus for detecting living bodies, using electromagnetic signals. The apparatus has a receiver device for electromagnetic signals that includes a device for obtaining frequency components that are characteristic in respect to living bodies.

U.S. Pat. No. 5,458,123 (Unger) teaches a patient monitoring system disposed with a transmitter worn by the patient. The system is disposed with sensors to monitor patients vital signs, and transmits the collected by RF signal to surrounding antennas that then transmit the information to central locations for analysis.

U.S. Pat. No. 5,361,070 (McEwan) teaches an Ultra-Wideband Radar Motion Sensor. For motion detection the sensors operate by starting at a fixed range and then sensing any change in the averaged radar reflectivity at that range.

U.S. Pat. No. 5,059,953 (Parsons et al.) teaches an Infrared overheat and fire detection system in aircraft.

U.S. Pat. No. 4,829,285 (Brand et al.) teaches an in-home emergency assist device. The devise is disposed with an alarm for sending out distress information when the user is in an abnormal position. The alarm system is worn upon the chest in a vest-like shirt, and relies upon a directional tilt switch which is triggered when a users body adopts a slumped over or lying down position on the floor.

### BRIEF SUMMARY OF THE INVENTION

An object of the present invention is to inform caregivers or emergency personnel when an individual has fallen or remains motionless in the residence for an abnormal length of time.

Another object of the present invention is for the digital image processor to generate an alarm signal that is transmitted to the caregiver or 911 personnel upon detection of an emergency situation.

Another object of the present invention is to use sensors located in each room of the residence to monitor activity throughout the dwelling.

Another object of the present invention is for the software to be disposed with a setup phase enabling the user to enter the number of monitored rooms in the residence; the number of sensors installed in each room, the location of each sensor, and the locations of each window and door within the monitored space.

Another object of the present invention is for the digital image processor software to store map data of the residence.

Another object of the present invention is for the software to be disposed with a capability to record an individual's movement over an extended period of time so that suspicious events can be compared to average activity for the purpose of detecting an emergency.

Another object of the present invention is to record the movement patterns of an individual over an extended period of time (i.e. two or more days) so that the system may detect changes in the individual's lifestyle.

Another object of the present invention is to use a digital image processor to receive motion data from the sensors and to detect falling events or periods of extended inactivity.

The manners in which the invention achieves its objects and other objects which are inherent in the invention will become more readily apparent when reference is made to the accompanying drawings wherein like numbers indicate corresponding parts throughout.

### BRIEF DESCRIPTION OF THE DRAWINGS

FIG. 1 is a front perspective view of a residence showing the location of a wireless detection module located in the residence that is coupled to a digital image processing unit.

FIG. 2 is the 3D wireless detection module.

FIG. 3 is a system block diagram of the wireless detection module

FIG. 4 is a block diagram of the digital image processor.

FIG. 5 is a representation of the digital image processor unit box

FIG. 6 is a block diagram of the digital image processor unit and the WAN/LAN.

FIG. 7 is an illustration of a Set Up menu for assigning WDMs to monitored rooms generated by the software program.

FIG. 8 is an illustration of a Set Up menu for WDM locations on each monitored room generated by the software program.

FIG. 9 is an illustration of a Windows & Door report generated by the software program.

FIG. 10 is an illustration of a User report generated by the software program.

FIG. 11 is the Algorithm Pseudo code for the Inactive Normal monitoring state.

FIG. 12 is the Algorithm Pseudo code for the Inactive Abnormal monitoring state.

FIG. 13 is the Algorithm Pseudo code for fall detection.

FIG. 14 is a representation of the signal transmission and receipt from the wireless detection module.

FIG. 15 is a further representation of the signal transmission and receipt from the wireless detection module.

### DETAILED DESCRIPTION OF THE PREFERRED EMBODIMENTS

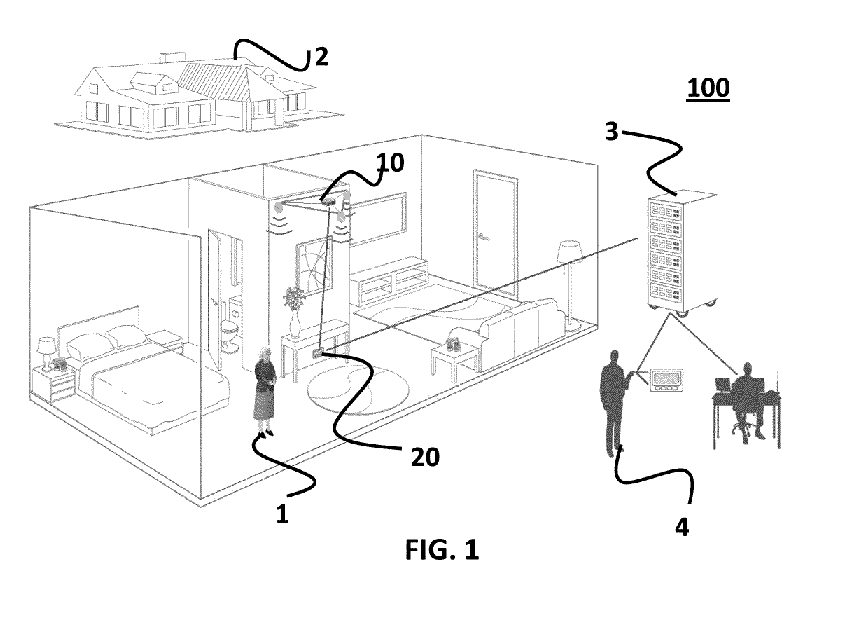

Referring now to the drawings wherein the showings are for purposes of illustrating a preferred embodiment of the present invention and not for purposes of limiting the same. A first embodiment of the invention is a fall and inactivity monitoring system 100 illustrated in FIG. 1 configured to monitor an individual 1 residing in a residence 2 that has fallen or remains motionless for an abnormal length of time. The system 100 is disposed with a sensor, the wireless detection module 10 mounted at ceiling level, though in other embodiments could be on the floor, in each room of the residence 2. Location and position data produced by the wireless detection module 10 is transmitted to the digital image processor 20 which in turns transmits the information to a local server 3 where it can be accessed by medical and emergency response personnel 4.

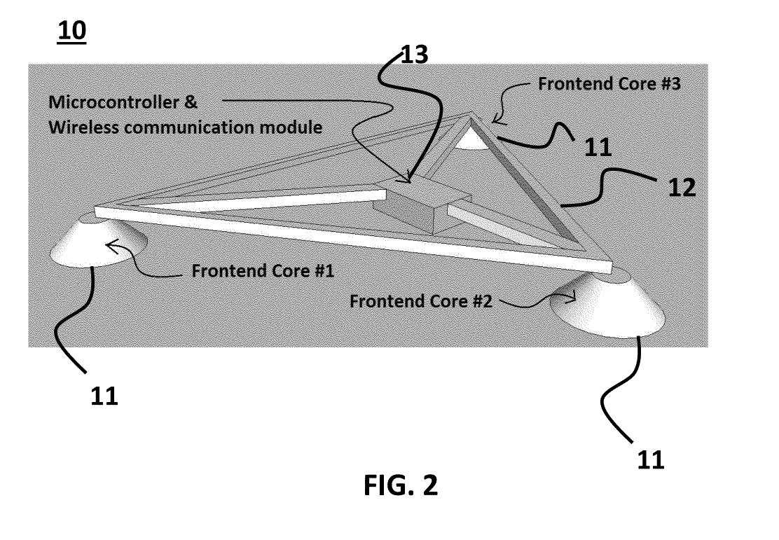

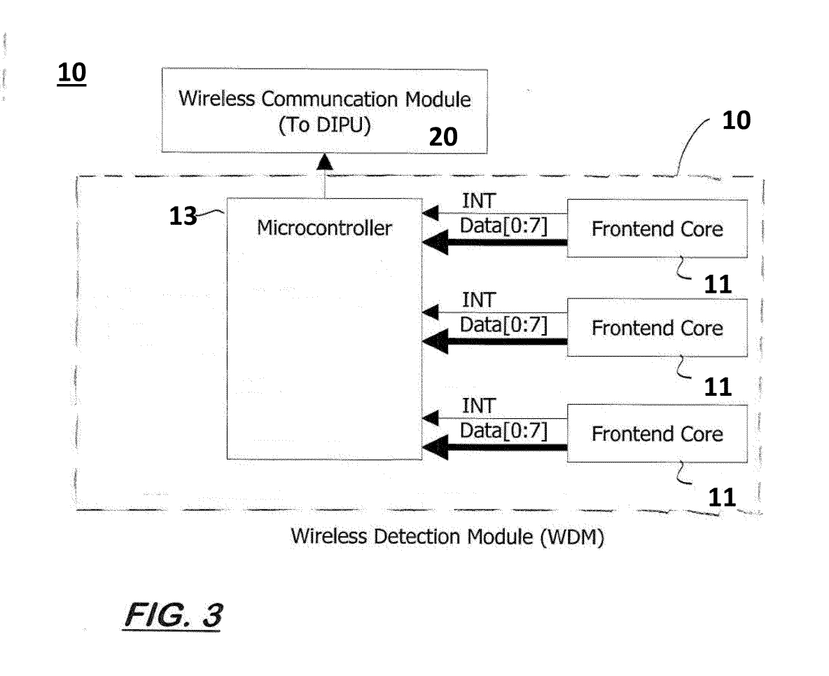

The wireless detection module 10 as shown in FIG. 2, consists of 3 radar-based sensors, the Frontend Cores #1-3, 11. The front end cores 11 are mounted on a triangular frame 12 so that each radar is equidistant from the other two. Each radar 11 independently emits and receives an electromagnetic signal and the collected signal data is transmitted to a microcontroller 13 mounted in the center of the triangular frame 12. The front end cores transmit radio wave signals into the residence, and then when an object in the residence is hit, the radio wave is reflected and returned to the front end core where it is also received. Each front end core is coupled to a timer that measures the round trip time for each signal and this process generates a radio image of the room in which it is mounted. The three radar based detection modules 11 continuously scan the room at the frequency of 3.1GHz to 10.6GHz. The antenna is designed to be wide band: 3.1 to 8.9 GHz with center frequency of 6 GHz, or alternatively 3.1 to 6.9 with center frequency of 5GHz. This takes advantage of widely available 801.11n Wi-Fi frequencies. A 5 GHz antenna may also be employed in alternate embodiments. The power spectral density emission limit is −41.3 dBm/MHz, and rate of 1/30 second. The system is designed to output 166.67 ns pulse which allows the spatial resolution of 1 inch. The maximum power output allowed by FCC is 0.0000741 mW. The maximum coverage area is 1900 square feet when the sensor mounted at the height of ten feet or 2500 square feet if mounted at a height of eight feet. The block diagram in FIG. 3 illustrates how data from each front end core 11 is sent to the microcontroller 13 which is disposed with a microprocessor that then sends it via the wireless communication module 13 to the digital image processor 20. While the above preferred embodiment utilizes a 3.1-10.6 GHz frequency range other ranges could use the disclosed method for example the 22 GHz range that is reserved for military applications if opened up to the public would work.

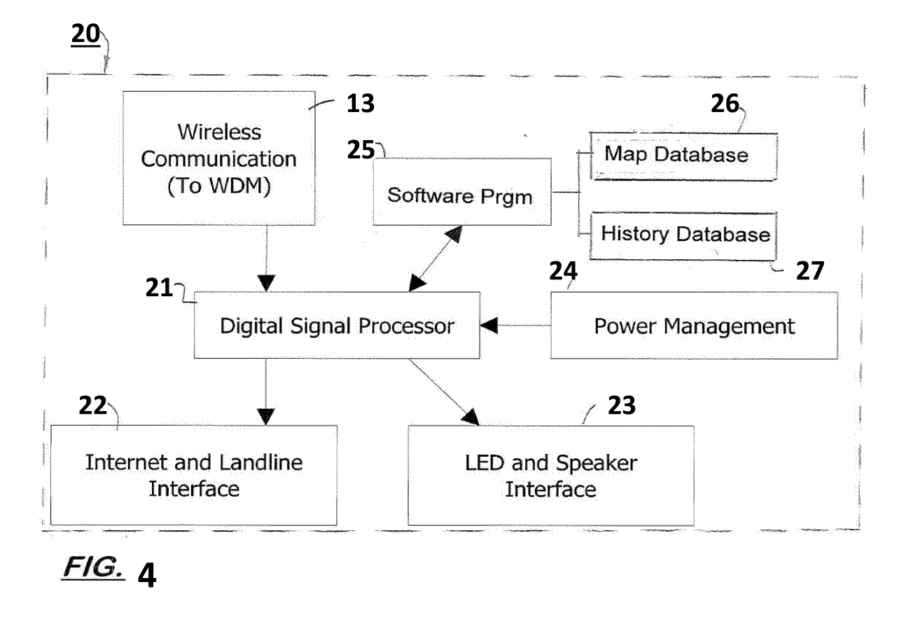

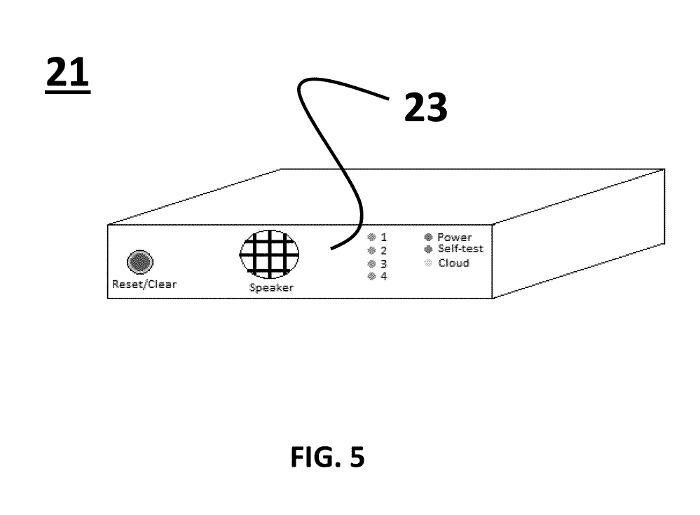

The block diagram in FIG. 4 illustrates the organization of the digital image processor 20. The microcontroller 13 transmits motion data wirelessly to the digital image processor 20, which consists primarily of a digital signal processor 21. The digital signal processor 21 runs software that makes multi-lateration measurements of the three return signals received by the front end cores, and this multi-lateration measurement then identifies the exact location of an object in the residence. The digital signal processor 21 is connected to internet and phone service 22 and is controlled by a power management system 24. The digital signal processor 21 operates software programming 25 which references two databases, a map database 26, and a history database 27. A representation of the digital signal processor 21 box is shown in FIG. 5. The digital signal processor is disposed with LEDs, speaker and phone jack, Ethernet and USB port interface (on the back of the box, not shown in FIG. 5) 23,

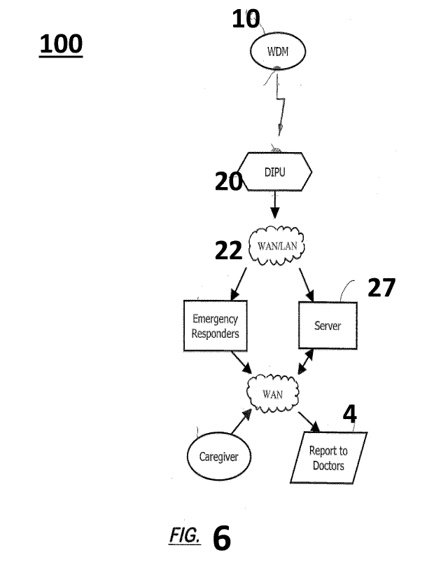

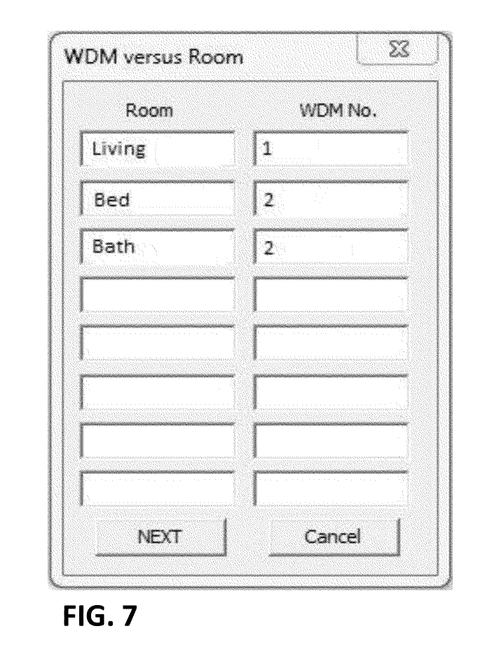

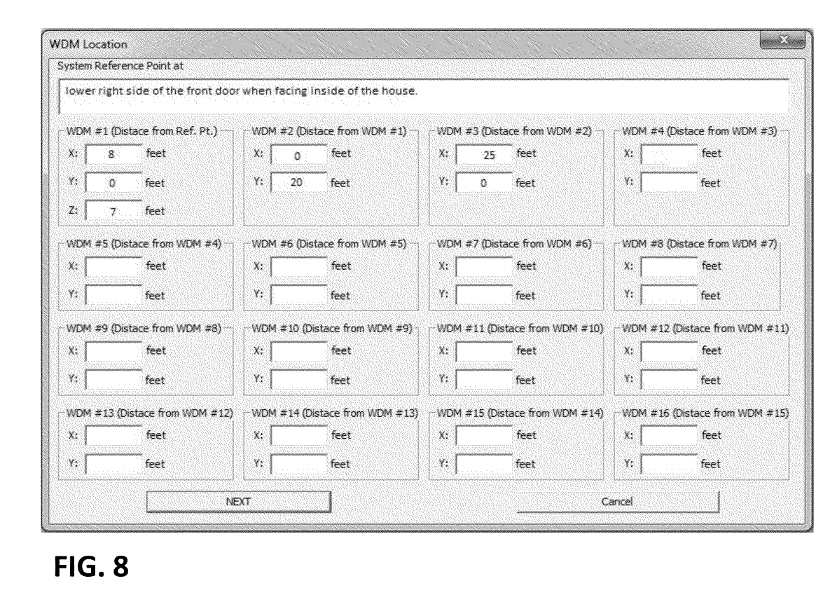

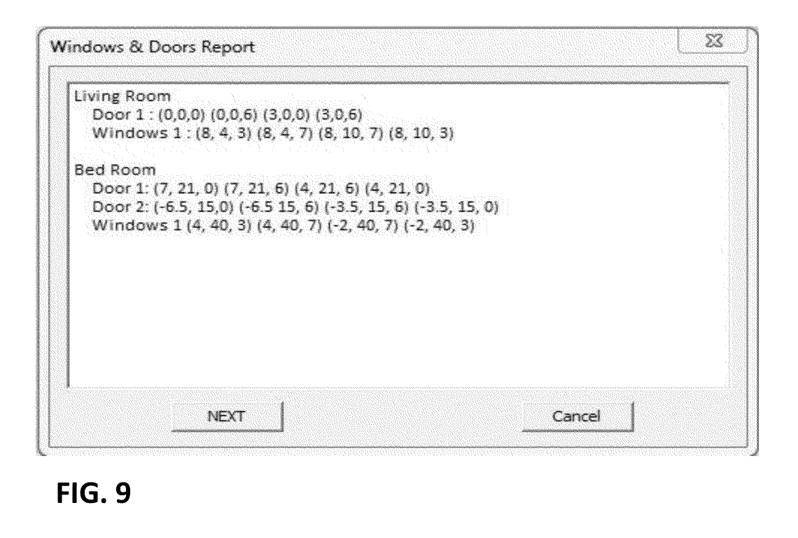

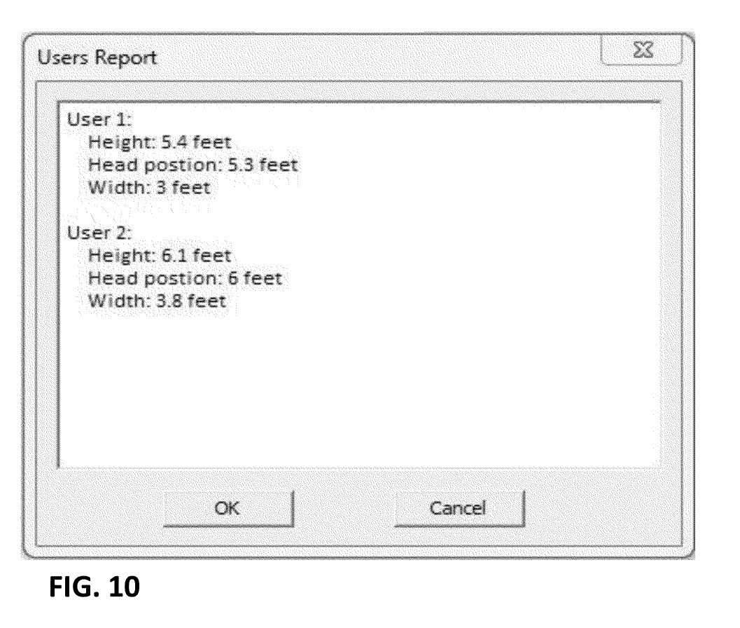

The block diagram in FIG. 6 provides additional detail on the flow of information in the system 100. The wireless detection module 10 generates position data which is wirelessly transmitted to the digital image processing unit 20, which is then connected to phone service by the way of landline and the internet by way of a wired or wireless network 22. The digital image processing unit 20 analyzes the position data to determine if an emergency condition is present, transmits the position data to the history database 27 where it can be accessed by medical and emergency response personnel 4. During initial setup of the fall and inactivity monitoring system 100, the rooms which are monitored by wireless detection modules 10 are named and the modules in each location are assigned numbers, or addresses, FIG. 7. In the next phase of set up, the length and width parameters of each room are entered into the system under the corresponding module number FIG. 8. Each room has a reference point assigned to it and during setup the location of each wireless detection module 10 is further specific in relation to the reference point by manually measuring the distance from the point to the WDM 10, shown in FIG. 8. Next the system creates a map database 26 of the residence 2 using the wireless detection modules 10 located in the residence. The map database 26 identifies the various rooms in the residence 2, such as a living room, a kitchen, a bath, a bedroom, a hall way, a closet, stairway, etc., and any the physically structures or barriers in each room, such as the walls, doors, windows, ceilings, steps, fixtures, floors, steps and furniture, located therein. As stated above, each room and hallway in the residence has at least one set of wireless detection modules 10 located therein. In some instances, a wireless detection module 10 may cover more than one room if practical. Next, the identity and location of windows and doors for each room FIG. 9 are manually entered into the software program 50. In one embodiment, an identification tag can be attached to the window and door so that the identity and location of these elements can be recorded in the map database with certainty. For example, to identify windows, first select ‘windows’ from the setup menu page, then place physical identification tag on each corner of window sequentially, the system will read the tag sequentially. The software program then generates a Windows & Door report FIG. 9. After the rooms have been identified and identification tags have been attached to each door and window, and after the wireless detection modules had been identified, the wireless detection modules 10 are then calibrated to the operational environment. The last step in setup is to tell the system about the users it will be monitoring, FIG. 10. Here the height and width of each user is measured by the system, in addition to the approximate vertical distance of the users head off the ground. This way the system can ascertain the posture and position of a given user. The software then generates a User report confirming the recorded measurements and data and the system is ready to begin scanning for motion data.

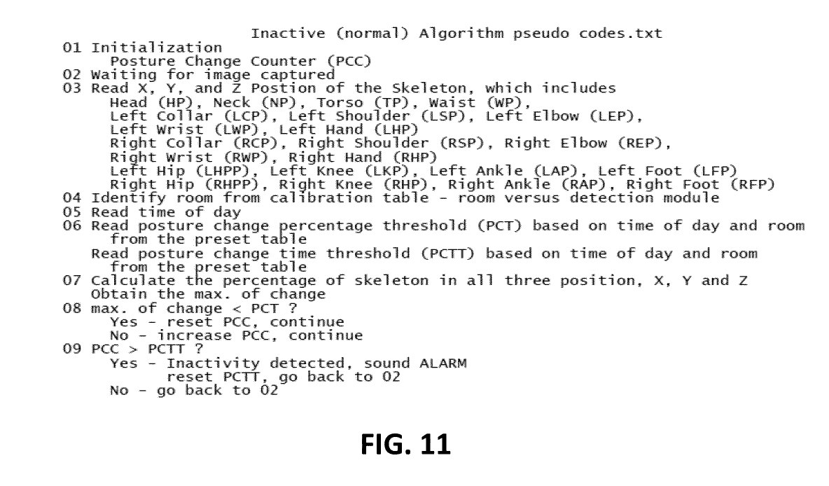

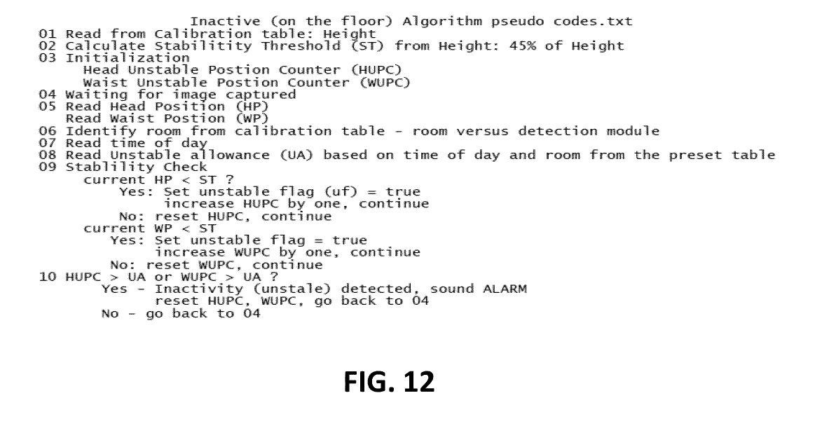

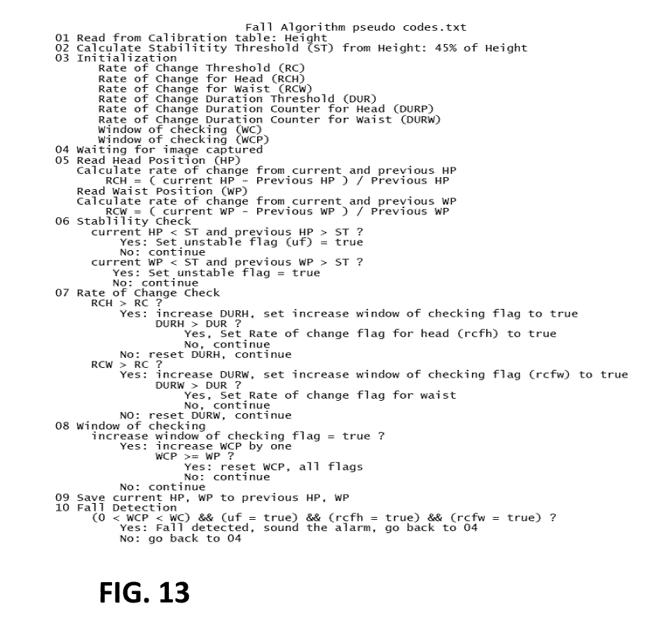

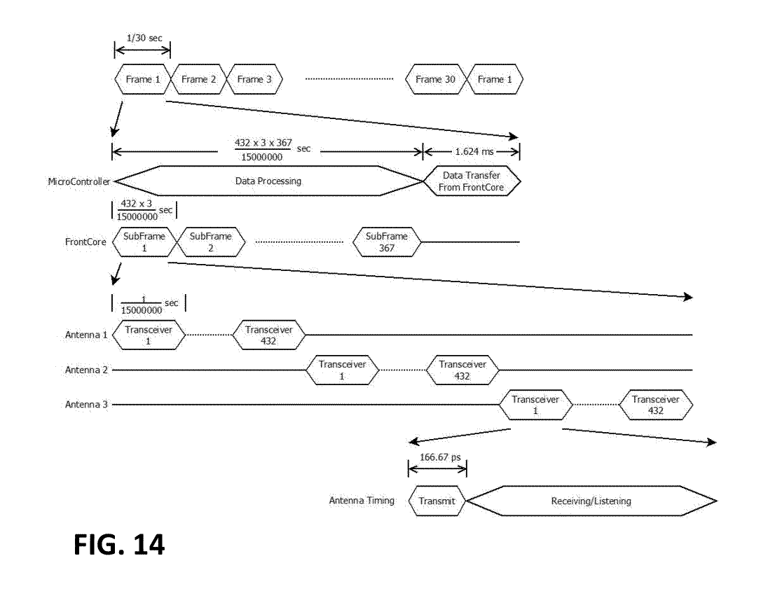

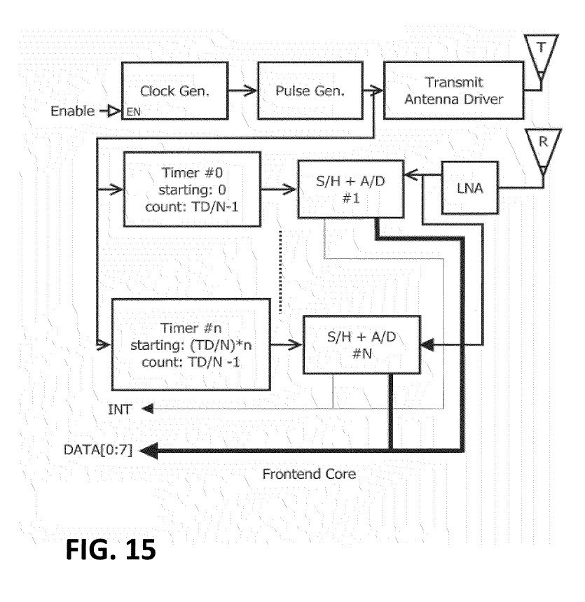

Under normal operating conditions, shown by the Inactive Normal Pseudocode in FIG. 11, the system will simply scan the room for the monitored individual, ascertain the location of the users body with respect to head, torso, waist, left and right collar, left and right shoulder, left and right elbow, left and right wrist, and left and right hand. The system will then ascertain the user's posture change and make a determination as to the user's physical location, body position, movement, and whether any emergency state is present. However, when a sudden vertical or horizontal movement is detected, shown in the Inactive Abnormal Pseudocode in FIG. 13, or a motionless state persists over a long period of time other than during sleeping hours, or an unexpected physical location is detected like for example the user lying on the floor for an extended period, shown in the Inactive Abnormal Pseudocode in FIG. 12, the software creates an alarm state. When in an alarm state a response subsystem 70 coupled to the digital image processor unit 30 notifies caregivers or emergency personnel. The response subsystem 70 includes a central server 120 that can be accessed by emergency monitoring service and/or by caregivers through personal computers 74 or mobile devices 98. Personal computers 74 and mobile devices 98 can receive notifications via text, SMS, Skype®, or phone call according to caregivers or emergency personnel preference. Additional representation of the a signal transmission and receipt from the wireless detection module and analysis of the received signal are provided in FIGS. 14 and 15.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A method of detecting changes in status of an individual in a residence comprising,
a. at least three wireless detection modules located in the residence and configured to continuously monitor the individual's location and movements in the residence, each the wireless detection module includes a 3D radar scanner;
b. a digital image processing unit coupled to the three wireless detection modules, the digital image processing unit includes working memory;
c. a fall and inactivity detection software program loaded into the working memory of the digital image processing unit, the software program configured to make multi-lateration measurements of the three return signals from the wireless detection modules to identify the exact location of an object in the residence, the software program creates a map database of the residence identifying the rooms in the and any the physically structures or barriers in the residence, the software program able to detected falls or inactivity of the individual inside the residence and generate an alarm signal, the software program being configured to create a history database of the individual's movements or inactivity prior to the alarm signal; and
d. a response subsystem coupled to the digital image processor and configured to notify a caregiver or emergency personnel when an alarm state from the software program is received.

2. The method of claim 1 wherein, the 3D radar scanner has a transmitter and receiver.

3. The method of claim 1 wherein, the 3D radar scanner has a transmitter and receiver capable of operation in the 3-10 gigahertz spectrum.

4. The method of claim 1 wherein, the alarm state is transmitted to a mobile device.

5. The method of claim 1 wherein, the alarm state is transmitted to a remote location.
